(19) United States
(12) Patent Application Publication
(10) Pub. No.: US 2008/0297435 A1
(43) Pub. Date: Dec. 4, 2008

(54) Enlarged Reality Visualization System with Pervasive Computation

(76) Inventors: Vagner Rogerio dos Santos, Sao Paulo (BR); Ana Luisa Holfing de Lima, Sao Paulo (BR); Ricardo Uras, Paraiso - SP (BR)

Correspondence Address: WILEY REIN LLP, 1776 K. STREET N.W., WASHINGTON, DC, 20006, US

(21) Appl. No.: 12/097,196

(22) PCT Filed: Dec. 12, 2006
(86) PCT No.: PCT/BR06/00272

§ 371 Date: Jun. 12, 2008

(30) Foreign Application Priority Data
Dec. 12, 2005 (BR) PI 0506340-0

(51) Int. Cl. G09G 5/00

(52) U.S. Cl. 345/8

(57) ABSTRACT

The present invention relates to an enlarged reality visualization system with pervasive computation. More specifically, this invention refers to a system that makes available data and information for individual's moving, spatial and geographical positioning, acquisition of data and information in real time or stored in some storage device, for users, such as professionals in general, in urban movement, hobbyists or visual deficient that need to transit by urban and/or building atmospheres, interacting with the objects and/or buildings, using wireless communication technologies. The present invention can be still used as system for generation of an electronic book, when the exhibition display is uncoupled from the head support and lay on a table and/or base or held with the hands.

### FIELD OF THE INVENTION

The present invention relates to an enlarged reality visualization system with pervasive computation. More specifically, this invention refers to a system that makes available data and information for individual's moving, spatial and geographical positioning, acquisition of data and information in real time or stored in some storage device, for users, such as professionals in general, in urban movement, hobbyists or visual deficient that need to transit by urban and/or building atmospheres, interacting with the objects and/or buildings, using wireless communication technologies.

The present invention can be still used as system for generation of an electronic book, when the exhibition display is uncoupled from the head support and lay on a table and/or base or held with the hands.

### BACKGROUND OF THE INVENTION

Head mounted visualization systems, popularly known as “Head Mounted Display” (HMD), were initially idealized for military use, attempting to supply, in real time, to the airplanes pilots military information on variables of the flight and of control of the armaments, radar control and combat data. The systems HMD are widely used in the martial and aerospace industry with very objective and punctual applications.

With the advent of wireless communication and the mobile communication, information that used to be available only in physical databases, such as computers and libraries, are being made available, by radio-frequency (RF), using specific communication protocols, as, for instance, bluetooth, Zigbee and WiFi. The communication via RF inaugurates a new generation of communication systems and a new culture of information. A culture of Man/Machine Interfaces (MMI) different from the one that existents now, in particular with the advent of the substitution of wires by RF communication.

Thus, the possibility of communication between objects and the human beings is opened, without the necessity of being physically linked by wires.

Habits and practice can be monitored and sent to places and/or objects, anticipating the necessary functions to the human's needs, such as to adjust an air conditioner, to start the engine of a car or to adjust an easy chair.

Besides, the use of radio-frequency (RFID) identification systems becomes more and more frequent. These RFID systems provide the generation of RF signs that carry information regarding, for instance, the object, place, environment, piece of furniture or property for which this was planed and designed, providing data relative to the most different variables, when necessary, such as: spatial positioning, temperature, the availability of products and services etc.

Based on the RFID systems and RF systems for mobile telephony, it can be obtained data and information of many points or chips embed in the most different environments and products, completing a wide network of interlinked points, that communicate with each other and provide information that can be accessed and/or consulted at any moment or place, where the individual is. For instance, a simple coffee machine in a bar can have a chip, that will make available information via RF for the people that are passing in front of that bar in that moment.

This whole information network generated by the RF devices for mobile telephony and RFID interlinked, making available information and data to the human beings, is characterized as pervasive computation.

For instance, through information of RFID systems, one can pass by the door of a library and the data receiving system can receive a message on the new books acquired by the library. That message can be sent, for instance, by the RFID system of the library that can be positioned at the entrance of the building, in the sidewalk or in another public place. Or, it can, through the mobile telephony service, receive information with images, texts, films etc, of the cultural activity of the library.

Thus, the possibility of applications in enlarged reality with pervasive computation is opened, making possible the increase of the amount of data and information in the vision field that an individual possesses of the real world, through the overlap of texts, images, application of vision computational, Graphic Computation/Virtual Reality.

The known devices in the state of art similar to this technology are the Eye Tracks. Eye Tracks are devices used in the industry to make available information of simulated virtual computing environments, not offering, however, the possibility of use as an enlarged reality system, as they do not offer RF interfaces and/or mobile technology and they do not present systems for processing interfaces for image overlap.

Some Eye Tracks are used to aid the visualization of low vision people, making possible the observation of objects focused on a camera positioned on plane objects, such as pictures and texts, not making possible the availability of other information.

The known systems in the state of art do not make possible the moving or the mobility in the urban environment of the individuals with or without any visual disabilities. Such systems do not offer to the user any information, except the information captured from the magnificent reading camera. These just make possible mere focus adjustments and position that are not automatic.

Therefore, the prior art does not have a head mounted visualization system (HMD) with pervasive computation that can be used like an Eye Track of common use for people who are visually disabled or not.

There is no prior art system that incorporates the possibilities of pervasive computation and mobility in the urban and building environment, or that makes available information coming from the environment, cellular information, objects with RFID or databases, putting in the visual field of the user more information than he is really seeing.

### SUMMARY OF THE INVENTION

The present invention overcomes the inconveniences generated by the traditional systems, as its design includes a head mounted visualization system (HMD) that can be used like an Eye Track of common use for people for people who are visually disabled or not.

The present invention has as one of its objects to provide an enlarged reality visualization system with pervasive computation and mobility in the urban and building environment, making available information coming from the environment, cellular information, RFID objects or databases, including in the visual field of the user more information than he is really seeing.

Another object of the present invention is to provide a system of generation of electronic book that is characterized by the digitization of objects, text and/or pictures presented in the display as if it was a real book, different from the head mounted visualization system (HMD) that makes available information in front of the eyes of the user.

### DESCRIPTION OF THE DRAWINGS

The preferred embodiments of accomplishment of the present invention will be described as follows, with reference to the enclosed drawings, in that:

FIG. 1 is a front perspective view of a representation of the head mounted visualization system.

FIG. 2 is a rear perspective of a representation of the head mounted visualization system seen.

FIG. 3 is a view in prospective view of a representation of the electronic book system.

### DETAILED DESCRIPTION OF THE INVENTION

The present invention refers to a system to be put in the head of an individual with visual disability or not.

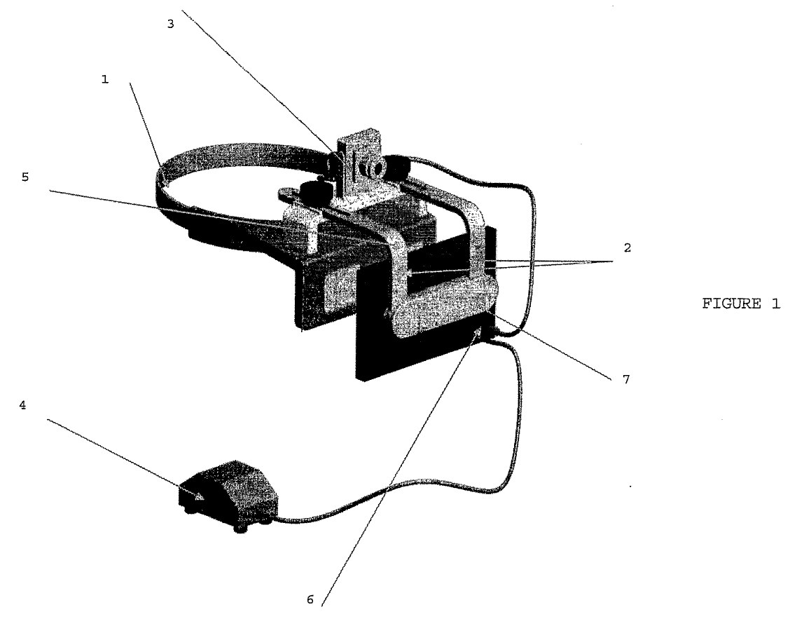

As illustrated in FIG. 1, this enlarged reality visualization system with pervasive computation comprises:
a support for head coupling (1);
ultrasound sensor (2);
   means for capture of proximate images (3) and distant images (4);
means for image magnification;
means for visualization of the captured information (5);
means for keying the mentioned means of image capture (6); and
means for receiving information (7).

As it can be observed in FIG. 1, said ultrasound sensor (2) are disposed in front of the system, making possible the identification of the distance between the user and the objects, thereby allowing the free passage of the user between objects and the urban environment.

In accordance with the preferred embodiment showed in FIG. 1, the present invention presents a communication system that makes possible, via wireless communication and RF communication protocols, the recognition of RFID communication signs that identify objects and/or obtain information from the environment where the user is located.

The system showed in FIG. 1 is designed to receive information, via RF signs, for instance, via mobile technology, using data, voice and video communication systems.

As showed in FIG. 1, through the means for receiving information (7), it can be made available in a display (5), located in front of the eyes of the user, either data supplied by the RFID systems that are captured by the information receiving system, or information that are received via RF from the mobile telephony system that are also captured by the information receiving system, digitally processed and sent to the display where are overlapped or, integrated to the images and/or digitalized information by the camera system. This provides a significant advantage of the present invention as it integrates the means for receiving information and data of image capture, providing to the user more information than he is really seeing by the camera systems.

All this integrated information and available in a TFT display make possible the creation of a enlarged reality visualization system with pervasive computation

This invention increases the information availability for individuals without visual disability and facilitates the life of visually disabled people, as it helps them in the locomotion and in the encounter of places and objects, even out of their reach or vision field.

Said means of image distancing capture (4) is a long distance camera that has an opening angle that makes possible to the user moving around urban and building obstacles. In accordance with the preferred embodiment of the invention, the camera (4) has an servo-controlled optical system that makes possible the auto-focus for close objects until approximately 50 cm, being automatically adjusted through the signs generated by said ultrasound sensor (2), with work interval of 6 cm up to 600 cm of obstacle capture, being its resting position 600 cm. Said auto-focus servo-controlled system is a c.c. motor with absolute encoder that adjusts the lenses of the optical system.

Still in accordance with a preferred embodiment, the means of capture of proximity images (3) is a small angle camera that has the function of enlarging the captured images of books and pictures for reading and observation of objects, designed to act as an automatic electronic magnifying glass with controlled enlargement adjustment by an electronic system that makes possible the inversion of the c.c. motor turn, actuated by a button of three positions that moves the camera, approximating or moving away from the pictures or texts, making possible, thereby, the adjustment of the enlargement. This system with automatic enlargement adjustment is not commercially available, having only simplified devices with manual adjustment.

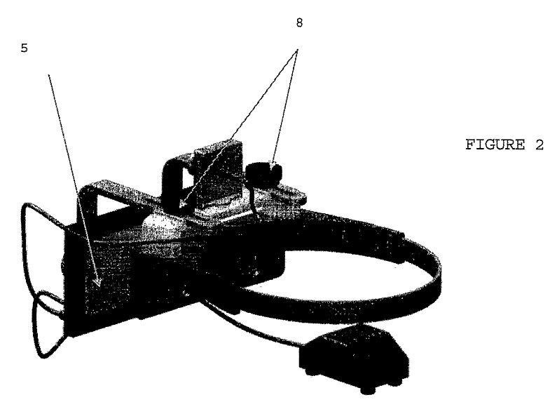

According to present invention preferably both cameras (3) and (4) have RCA outlets with automatic conversion for the sign of the TFT display (5). As showed in FIG. 2, the display (5) has two video inlets (8) with operation selection, making possible to the user to define, at any moment, if s/he wants to observe distant objects or close objects. In accordance with the preferred embodiment, the operation selection of the means for visualization (5) is carried out manually. However, this selection can still be accomplished by a voice recognition system that makes possible to the user greater mobility and movement freedom. This system can also be implemented by interpretation of electric-biological signs coming from the muscular movements of the user's face or any other muscle.

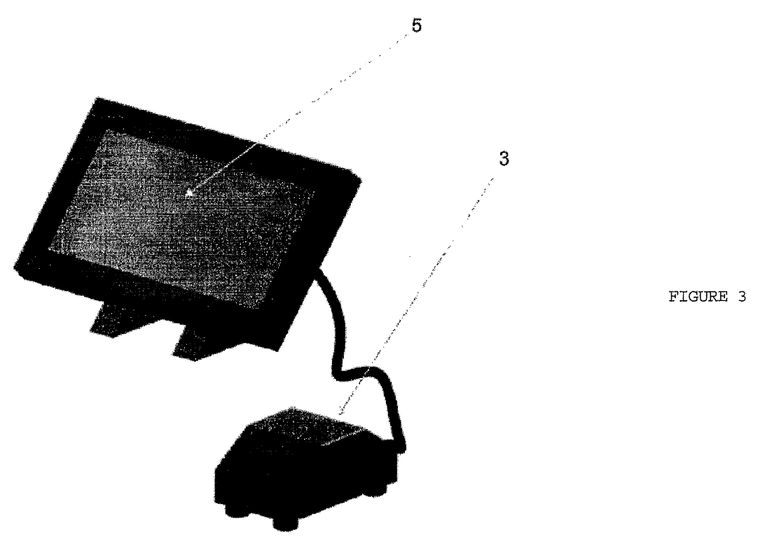

In accordance with another embodiment of the invention, showed in FIG. 3, the display (5) can be uncoupled from the head support and used as a system of generation of digital book for reading of texts and visualization graphical papers.

The system of generation of digital electronic book includes the proximity camera (3) and means for visualization (5) that makes possible the automatic control of the focus for visualization of pictures and/or texts prior to digitalizing them. The digitalized images are sent to said means of visualization (5) and presented according to the adjusted enlargement.

The system of electronic book has similarity to a retro-flashlight system that reproduces an image and/or text through an optical system, making possible the reading and observation of texts and/or drawings.

The present invention as described will be evident to a person skilled in the art that many modifications and changes can be made in the invention, without departing from the spirit or scope of the mentioned invention, as shown in the present specification.

1) An enlarged reality visualization system with pervasive computation characterized by comprising:
a support for head coupling (1);
ultrasound sensor (2);
means for capture of proximate images (3) and distant images (4);
means for image magnification;
means for visualization of the captured information (5);
means for keying the mentioned means of image capture (6); and
means for receiving information (7), through which it can be made available, in said means for visualization of the captured information (5), either data supplied by the RFID systems that are captured by the information receiving system, or information that are received via RF from the mobile telephony system, that are also captured in the information receiving system, digitally processed and sent to said means of visualization (5), where they are overlapped or integrated to the images and/or information digitalized by the means of image capture (3, 4), providing to the user more information than s/he is really seeing, from the means of image capture (3, 4).

2) System, as claimed in claim 1, wherein said means of image distancing capture (4) is a long distance camera that has an opening angle that makes possible the user moving around urban and building obstacles.

3) System, as claimed in claim 1 or 2, wherein said means of image distancing capture (4) has a servo-controlled optical system that makes possible the auto-focus for close objects until approximately 50 cm, being automatically adjusted through the signs generated by said ultrasound sensor (2).

4) System, as claimed in claim 3, wherein said ultrasound sensor (2) has a work interval of 6 cm up to 600 cm of obstacle capture, being its resting position 600 cm.

5) System, as claimed in claim 3, wherein said auto-focus servo-controlled system is a c.c. motor with absolute encoder that adjusts the lenses of the optical system.

6) System, as claimed in claim 1, wherein said means of capture of proximal images (3) is a small angle camera with enlargement adjustment controlled by an electronic system that makes possible the inversion of the c.c. motor turn, actuated by a button of three positions that moves the camera, approximating or moving away the images, making possible, thereby, the enlargement adjustment.

7) System, as claimed in claim 1, wherein said means for capture of proximal (3) images and distant images (4) have RCA outlets with automatic conversion for the sign of the means for visualization (5).

8) System, as claimed in claim 1, wherein said means for visualization of the captured information (5) have two video inlets (8) with operation selection, making possible to the user to define, at any moment, if s/he wants to observe distant objects or close objects.

9) System, as claimed in claim 8, wherein the selection of objects to be visualized in said means for visualization (5) can be accomplished by a voice recognition system for interpretation of electric biological signs coming from the muscular movement of the user's face or any other muscle, or still manually.

10) enlarged reality visualization system with pervasive computation characterized by comprising:
means for capture of distant (4) images;
means for visualization of the captured information (5), said means adapted to make possible the automatic control of the focus for visualization of images prior to digitalizing, the digitalized images being sent to said means for visualization (5) and presented in accordance with the enlargement adjusted.

11) System, as claimed in claim 10, wherein said means of capture of proximal images (3) is small angle a camera, with enlargement adjustment controlled by an electronic system that makes possible the inversion of the c.c. motor turn, actuated by a button of three positions that moves the camera, approximating or moving away the images, making possible, thereby, the enlargement adjustment.

12) System, as claimed in claim 10, wherein said means of capture of proximal images (3) have RCA outlets with automatic conversion for the sign of the means for visualization (5).
